(19) United States
(12) Patent Application Publication
(10) Pub. No.: US 2026/0320019 A1
(43) Pub. Date: Oct. 15, 2026

(54) DATA SPARSITY INDEX LIFECYCLE MANAGEMENT

(71) Applicant: International Business Machines Corporation, Armonk, NY (US)

(72) Inventors: HUI WANG, BEIJING (CN); Mai Zeng, Shi Jing Shan (CN); Peng Hui Jiang, BEIJING (CN); Juan Zhang, BEIJING (CN)

(73) Assignee: International Business Machines Corporation, Armonk, NY (US)

(21) Appl. No.: 19/179,154

(22) Filed: Apr. 15, 2025

(51) Int. Cl. G06F 16/22

(52) U.S. Cl. CPC G06F 16/2272

(57) ABSTRACT

An embodiment configures an indexing mechanism of a database management system application to enforce an index lifecycle management (ILM) policy. The embodiment constructs using a feature map module of the database management system application a set of feature maps based on the set of features extracted from the database activity data. The embodiment generates using a decision analysis module of the database management system application a data density decision curve based on the set of feature maps. The embodiment identifies a first candidate data set belonging to a first index of the set of indices associated with a first stage of the ILM policy, the first candidate data set eligible for dilution based on the data density decision curve. The embodiment dilutes using a data sparsity module of the database management system application, upon identifying the first candidate data set eligible for dilution, the first candidate data set.

### BACKGROUND

The present invention relates generally to database management. More particularly, the present invention relates to a method, system, and computer program providing data sparsity index lifecycle management.

Database management involves organizing, storing, and maintaining data stored on a database to ensure efficient storage, retrieval, performance, and reliability of the stored data. Indexing is the process of creating a data structure that acts as a record system that allows for faster and more efficient search and retrieval. When data is indexed, key fields or terms are extracted and organized into an index, which maps terms to the documents they appear in. An index enables a database system to quickly locate relevant data without scanning the entire dataset.

There are various types of databases architectures currently in existence. One type of database is the relational database. A relational database organizes data into tables with rows and columns, where each row represents a record, and each column represents an attribute. Data in relational databases is structured and related to each other through primary and foreign keys, enabling queries and transactions using SQL. Further, a relational database is a type of database that supports indexing and that can benefit from index lifecycle management (ILM). Indexes may impact query performance as data in the database evolves over time, and the effectiveness of indexes may degrade due to factors such as data growth, data distribution changes, and query patterns. By proactively managing indexes, relational databases can improve query performance and responsiveness for users and applications while reducing computational resource consumption.

Index lifecycle management (ILM) refers to the process of managing indexes throughout their lifecycle, from creation to maintenance, archival, and/or deletion. This process involves identifying and creating indexes on appropriate columns, monitoring index usage and performance, and periodically optimizing or removing indexes that are no longer beneficial. Further, ILM involves automating how indexes are handled over time, particularly in systems that deal with large volumes of time-based or log data. ILM policies define how and when indexes transition through phases, such as for example, hot, warm, cold, and delete phases.

Relational databases benefit from index lifecycle management by providing that indexes are properly maintained to support efficient query processing. By regularly analyzing index usage and performance metrics, database administrators and applications can identify redundant or underutilized indexes and take corrective actions such as rebuilding indexes, reorganizing indexes, or removing unnecessary indexes. ILM helps prevent index fragmentation, reduces storage overhead, and improves overall database performance by ensuring that indexes are aligned with the evolving data and query workload. Accordingly, ILM improves indexing and contributes to more effective and efficient automated database management systems and methods.

### SUMMARY

The illustrative embodiments provide for data sparsity index lifecycle management. An embodiment includes configuring an indexing mechanism of a database management system application to enforce an index lifecycle management (ILM) policy, the ILM policy defining a set of stages, each stage defining respective data handling permissions for indices of a set of indices managed by the indexing mechanism The embodiment also includes executing using a monitor module of the database management system application a monitoring process, the monitoring process producing database operational data. The embodiment also includes extracting using a collector module of the database management system application a set of features from the database operational data. The embodiment also includes constructing using a feature map module of the database management system application a set of feature maps based on the set of features extracted from the database operational data. The embodiment also includes generating using a decision analysis module of the database management system application a data density decision curve based on the set of feature maps. The embodiment also includes identifying using the decision analysis module of the database management system application a first candidate data set belonging to a first index of the set of indices associated with a first stage of the ILM policy, the first candidate data set eligible for dilution based on the data density decision curve. The embodiment also includes identifying using the decision analysis module of the database management system application a second candidate data set belonging to a second index of the set of indices associated with a second stage of the ILM policy, the second candidate data eligible for dilution based on the data density decision curve. The embodiment also includes diluting using a data sparsity module of the database management system application, upon identifying the first candidate data set eligible for dilution, the first candidate data set. The embodiment also includes diluting using the data sparsity module of the database management system application, upon identifying the second candidate data set eligible for dilution, the second candidate data set.

An embodiment includes a computer usable program product. The computer usable program product includes a computer-readable storage medium, and program instructions stored on the storage medium.

An embodiment includes a computer system. The computer system includes a processor, a computer-readable memory, and a computer-readable storage medium, and program instructions stored on the storage medium for execution by the processor via the memory.

### BRIEF DESCRIPTION OF THE DRAWINGS

The novel features believed characteristic of the invention are set forth in the appended claims. The invention itself, however, as well as a preferred mode of use, further objectives, and advantages thereof, will best be understood by reference to the following detailed description of the illustrative embodiments when read in conjunction with the accompanying drawings, wherein:

FIG. 1 depicts a block diagram of a computing environment in accordance with an illustrative embodiment;

FIG. 2 depicts a block diagram of an example computing environment in accordance with an illustrative embodiment;

FIG. 3 depicts a block diagram of an example software module in accordance with an illustrative embodiment;

FIG. 4 depicts a block diagram of an example Index Lifecycle Management Policy in accordance with an illustrative embodiment;

FIG. 5 depicts a block diagram of an example process for data sparsity index lifecycle management in accordance with an illustrative embodiment;

FIG. 6 depicts a block diagram of example feature mappings in accordance with an illustrative embodiment; and

FIG. 7 depicts a flowchart of an example process for data sparsity index lifecycle management in accordance with an illustrative embodiment.

### DETAILED DESCRIPTION

A query is a fundamental operation in a database system that involves requesting information or data from a database. A query serves as a means for users or applications to interact with the database, retrieve specific data based on defined criteria, and perform various operations on the data. When a query is executed, the query typically includes a structured command or statement written in a query language such as SQL (Structured Query Language). The query language provides a standardized syntax and set of commands for interacting with the database, specifying the desired data to be retrieved, manipulated, or analyzed.

An index is a type of data structure that enables information to be located within a database. Accordingly, the index serves as a lookup mechanism that stores the location of the data to be retrieved based on the query request, allowing the database system to quickly locate and access the desired data without scanning the entire dataset. When a query is executed against a database table, the database management system can leverage the index to speed up the data retrieval process. Instead of performing a full table scan to locate the requested data, the system can use the index to directly navigate to the relevant data based on the query conditions.

The index is typically created on one or more columns of a table, allowing the database system to organize and sort the data in a structured manner. Each entry in the index contains a key value and a pointer to the corresponding data location in the table. When a query is issued, the database system compares the query conditions with the index entries to identify the specific data records that match the query criteria. By matching the query to the index, the database system can significantly reduce the time and resources required to retrieve the requested information. The index enables the system to perform index lookups, which are much faster than scanning the entire dataset, especially for tables with a large number of records.

Indices are expected to grow in size as data saved in databases grows over time. When huge volumes of data are continuously ingested into an index, the computational overhead of querying increases which causes querying efficiency to decline. Given the rate at which generative technology is booming, data generation is expected to continue to grow, leading to certain deterioration of index searching performance over time.

Index Lifecycle Management (ILM) is the management of indices over time, including to control their size, performance, and retention without manual intervention. ILM includes providing high query performance and reduced costs by periodically rolling over the data to new indices. At present, the life cycle management of Elasticsearch(ES) uses the time and size of index establishment as parameters to divide the data into different stages, so as to manage the data. This method includes various deficiencies, including the need to manually define the data processing mode of each stage. Further, currently existing methods only allow for data to be deleted in the delete stage, while the space occupied in the preceding stages remains unchanged.

The present disclosure addresses the deficiencies described above by providing a process (as well as a system, method, machine-readable medium, etc.) that develops a dynamic data sparsity index lifecycle management system. Embodiments of the present disclosure extract, transmit, modify, and/or delete data at different stages, so that the data can maintain a certain availability at a current stage while saving storage space. Disclosed embodiments utilize limited storage more effectively than previous index lifecycle management systems as well as provide more accurate IT operational metric data insights. To dynamically manage the data sparse in IT operational metric data lifecycle, embodiments of the present disclosure provide a sparse processing method, which can dilute the data at different stages with different density, thereby saving storage space while keeping the data available.

An embodiment of the sparse processing method involves strategically diluting the data at different stages of the data lifecycle with varying densities, leading to storage space savings while maintaining that some data remains accessible and usable. An embodiment includes identifying data points or metrics that are less critical or less frequently accessed and applying data dilution techniques to reduce the storage footprint of such data while maintaining the integrity and usability of the information. By diluting the data at different stages with varying densities, the sparse processing method effectively optimizes storage space utilization. Data that is deemed less important, not relevant, or historical in nature can be compressed, aggregated, or summarized to occupy less storage space, thereby freeing up resources for more critical and real-time data. This dynamic management of data density ensures that storage resources are efficiently utilized without compromising the availability of essential information.

By intelligently diluting data based on its relevance and usage patterns, systems and organizations can optimize their storage infrastructure, reduce costs associated with storing large volumes of data, and streamline data management processes. Accordingly, the sparse processing method introduced in embodiments of the present disclosure offers a practical and efficient approach to managing sparse data in IT operational metric data lifecycle. By dynamically adjusting data density at different stages, systems and organizations can achieve significant storage space savings, improve data accessibility, and enhance overall data management efficiency in IT operations.

As used throughout the present disclosure, the term “data dilution” refers to a process used to reduce the density or granularity of data stored in a database. Data dilution typically involves selectively reducing the level of detail or precision of data, which may include aggregating, summarizing, or compressing data points to occupy less storage space while still retaining essential information. Data dilution is often employed to optimize storage efficiency, especially for datasets that contain a large volume of data or historical information that may not be frequently accessed or critical for real-time operations. By diluting data, systems and organizations can reduce storage costs, improve query performance, and streamline data management processes without compromising the integrity or usability of the data. Embodiments of the present disclosure consider implementing data retention policies to automatically archive or delete older or less critical data based on predefined criteria, such as data age or usage frequency, and/or according to a data density curve.

As used throughout the present disclosure, the term “index lifecycle management” (or simply “ILM”) refers to any system or process related to managing an index over a period of time.

As used throughout the present disclosure, the term “IT operational data” refers to structured and unstructured information generated and collected during operations of an information technology (IT) system or environment. This data may include a wide range of metrics, logs, events, configurations, performance indicators, and other relevant information that may be useful for monitoring, managing, and optimizing IT infrastructure, applications, and services. IT operational data may include real-time and historical data related to the performance, availability, security, and utilization of IT resources such as servers, networks, databases, applications, and storage systems.

As used throughout the present disclosure, the term “feature mapping” refers to a process used in data analysis and machine learning for identifying and extracting meaningful attributes or characteristics (features) from the data and organizing the extracted features into structured feature maps that represent the data in a format suitable for processing. These features may include quantitative metrics, categorical variables, or other data points that provide data insights. Feature maps typically consist of rows (data instances) and columns (individual features), where each cell contains a specific feature value. Embodiments include assigning labels or categories to the data instances based on the classification task. These labels define the classes or categories to which the data instances belong, enabling the system to learn and differentiate between different classes during analysis or classification. Embodiments include mapping the extracted features to the corresponding data instances to create structured feature maps. Each feature map contains a set of features along with their associated class labels, providing a comprehensive representation of the data that can be used for analysis, modeling, or decision-making. As used throughout the present disclosure, the term “feature map” refers to output of a feature mapping process, representing the transformed version of the input data in a new feature space. The resulting feature space can then be used as input to a machine learning algorithm or other analysis technique.

As used throughout the present disclosure, the term “feature extraction” refers to transforming the input data into a new set of features that capture the most important information. As used throughout the present disclosure, the term “feature transformation” refers to applying a function to the input data to transform the data into a new set of features. As used throughout the present disclosure, the term “feature selection” refers to selecting a subset of the available features that are most relevant to a task at hand.

As used throughout the present disclosure, the term “feature data” refers to a data set that includes numerical and/or categorical values that represent measurable properties or characteristics of the input data after it has undergone feature extraction, transformation, or selection. Feature data serves as the input to analytical models or machine learning algorithms and encapsulates the information used to make predictions, classifications, or other forms of analysis.

As used throughout the present disclosure, the term “density curve” refers to a graphical representation of the probability distribution of a continuous random variable. Density curves provide a tool for visualizing the distribution of query-related metrics, such as response times, query frequencies, or parameter values. Further, density curves provide a smooth approximation of how data points are spread across a continuous range, which helps to identify trends, central tendencies, and anomalies in query performance. For instance, a database administrator could use a density curve to understand the spread of query latencies and identify whether a significant number of requests are experiencing unusually high response times.

The area under the data density curve represents the probability of a data point falling within a specific range of values. By analyzing the shape and characteristics of the data density curve, statisticians and data analysts can gain insights into the central tendency, variability, and distribution of the data. The data density curve is a valuable tool for understanding the underlying patterns and trends in a dataset, identifying outliers, and making informed decisions based on the distribution of data values.

As used throughout the present disclosure, the term “data sparsity” refers to a situation where a dataset contains a large or predefined number of missing, zero, or null values, meaning that most of the data fields are empty or unpopulated. Illustrative embodiments include introducing data sparsity into various phases or stages of an index lifecycle management system. Introducing data sparsity at different stages of an Information Lifecycle Management (ILM) may include managing and optimizing the density of data based on its relevance, importance, and usage patterns throughout its lifecycle. Illustrative embodiments further consider deleting the related index and edge data from each stage including hot and warm cold storage. In a typical index lifecycle management system, data may be removed during a final or delete stage of an ILM Policy. Embodiments include modifying and/or deleting data at different degrees at different stages rather than being deleted at a final stage.

As used throughout the present disclosure, the term “data density decision curve” refers to a graphical representation that illustrates the relationship between data density and decision outcomes. This curve is constructed based on the density of data points in a dataset and the decisions made based on that data. The data density decision curve provides insights into how the density of data influences the decision-making process and outcomes. The data density decision curve helps visualize the threshold at which data density influences the decision boundary, indicating the point at which decisions may change based on the availability or sparsity of data. The data density decision curve helps in determining the appropriate stages and extent of index dilution based on the density of data points and their impact on query processing efficiency throughout the data lifecycle.

As used throughout the present disclosure, the term “polyline sparsity” refers to the process of removing unnecessary points (vertices) from a polyline (a connected sequence of line segments), while still preserving its overall shape. Polyline sparsity reduces the data needed to store or process the polyline, since there are fewer points as a result. Also, polyline sparsity causes data visualization to become clearer, since reducing the number of points can reduce visual noise, making the important features of the shape easier to see.

Embodiments of the present disclosure provide a sparse processing method to dilute data at different stages with different density. Embodiments of the present disclosure increase storage space while maintaining data availability and increasing index processing speed.

The following description provides examples of embodiments of the present disclosure, and variations and substitutions may be made in other embodiments. Several examples will now be provided to further clarify various aspects of the present disclosure.

Example 1: A computer-implemented method that comprises configuring an indexing mechanism of a database management system application to enforce an index lifecycle management (ILM) policy, the ILM policy defining a set of stages, each stage defining respective data handling permissions for indices of a set of indices managed by the indexing mechanism. The method further comprises executing using a monitor module of the database management system application a monitoring process, the monitoring process producing database operational data. The method further comprises extracting using a collector module of the database management system application a set of features from the database operational data. The method further comprises constructing using a feature map module of the database management system application a set of feature maps based on the set of features extracted from the database operational data. The method further comprises generating using a decision analysis module of the database management system application a data density decision curve based on the set of feature maps. The method further comprises identifying using the decision analysis module of the database management system application a first candidate data set belonging to a first index of the set of indices associated with a first stage of the ILM policy, the first candidate data set eligible for dilution based on the data density decision curve. The method further comprises identifying using the decision analysis module of the database management system application a second candidate data set belonging to a second index of the set of indices associated with a second stage of the ILM policy, the second candidate data eligible for dilution based on the data density decision curve. The method further comprises diluting using a data sparsity module of the database management system application, upon identifying the first candidate data set eligible for dilution, the first candidate data set. The method further comprises diluting using the data sparsity module of the database management system application, upon identifying the second candidate data set eligible for dilution, the second candidate data set.

The above limitations advantageously enable the efficient index data handing over the lifecycle of an index data structure corresponding to a database management system. Diluting data from multiple indexes at multiple stages of an index lifecycle management (ILM) policy reduces the amount of computer resources used for storing index data. Further, the processing speed of queries increases since there is less data to be searched through in an index data structure that has been diluted compared to an index data structure that has not been diluted.

Example 2: The limitations of Example 1, where the method further comprises identifying using the decision analysis module of the database management system application a third candidate data set belonging to a third index of the set of indices associated with a third stage of the ILM policy, the third candidate data eligible for dilution based on the data density decision curve and diluting using the data sparsity module of the database management system application, upon identifying the third candidate data set eligible for dilution, the third candidate data set.

The above limitations advantageously enable diluting data from multiple indexes at multiple stages of an index lifecycle management (ILM) policy. Accordingly, the above limitations enable index data to be diluted for a first index corresponding to a first stage of an ILM policy, a second index corresponding to a first stage of an ILM policy, and a third index corresponding to a third stage of an ILM policy. Previous methods only allow data to be deleted from an index of single stage of an ILM policy, whereas the above limitations provide data to be deleted from multiple indexes at multiple stages of an ILM policy.

Example 3: The limitations of Example 1, where the method further comprises identifying using the decision analysis module of the database management system application a fourth candidate data set belonging to a fourth index of the set of indices associated with a fourth stage of the ILM policy, the fourth candidate data eligible for dilution based on the data density decision curve and diluting using the data sparsity module of the database management system application, upon identifying the fourth candidate data set eligible for dilution, the fourth candidate data set.

The above limitations advantageously enable diluting data from multiple indexes at multiple stages of an index lifecycle management (ILM) policy. Accordingly, the above limitations enable index data to be diluted for a first index corresponding to a first stage of an ILM policy, a second index corresponding to a first stage of an ILM policy, and a third index corresponding to a third stage of an ILM policy, and a fourth index corresponding to a fourth stage of an ILM policy. Previous methods only allow data to be deleted from an index of single stage of an ILM policy, whereas the above limitations provide data to be deleted from multiple indexes at multiple stages of an ILM policy.

Example 4: The limitations of Example 1, where the diluting the first candidate data set is according to a first degree, where the diluting the second candidate data set is according to a second degree, and where the first degree is different from the second degree.

The above limitations advantageously enable adapting the degree of index dilution based on the stages of the ILM policy to align index structures with changing data lifecycle requirements. By adjusting the level of index dilution as data progresses through different stages of its lifecycle, the limitations enable indexes to remain relevant to the current data characteristics and usage patterns. As data ages and becomes less frequently accessed, index structures are strategically diluted to reduce storage overhead and improve query efficiency for less relevant data.

Example 5: The limitations of Example 1, where the generating the data density decision curve based on the feature maps comprises constructing a hybrid polynomial regression model based on the feature maps, the hybrid polynomial regression model outputting the data density decision curve responsive to inputting the feature maps.

The above limitations advantageously enable more accurate modeling to capture complex relationships and patterns in the data. Further, the polynomial regression model based on the input feature maps provides a more strategic and efficient process for managing index data. The output of the hybrid polynomial regression model, which is the data density decision curve, provides a responsive and dynamic visualization of data density patterns based on the input feature maps. These limitations provide insights into data density variations, to make informed decisions based on data-driven analysis, and optimize strategies for data management and resource allocation.

Example 6: The limitations of Example 1, where the method further comprises modifying the density curve, the modifying the density curve producing a modified density curve, the modified density curve comprising fewer nodes than the density curve and diluting using the data sparsity module of the database management system application the first candidate data set based on the modified density curve.

The above limitations advantageously enable improved data visualizations by reducing the number of nodes in the density curve and simplifying the complexity of the curve. The data density decision curve visualizes the distribution of data points and their density, highlighting areas of data sparsity and concentration. When points are removed from the curve, it signifies a reduction in the density or importance of those data points in the dataset. This reduction in data density can be translated to the removal or dilution of index data that corresponds to the less essential or less frequently accessed data points. By aligning the removal of points from the data density decision curve with the removal of index data, the above limitations optimize index structures by focusing on the most relevant and impactful data points to preserve.

For the sake of clarity of the description, and without implying any limitation thereto, the illustrative embodiments are described using some example configurations. From this disclosure, those of ordinary skill in the art will be able to conceive many alterations, adaptations, and modifications of a described configuration for achieving a described purpose, and the same are contemplated within the scope of the illustrative embodiments.

Furthermore, simplified diagrams of the data processing environments are used in the figures and the illustrative embodiments. In an actual computing environment, additional structures or components that are not shown or described herein, or structures or components different from those shown but for a similar function as described herein may be present without departing the scope of the illustrative embodiments.

Furthermore, the illustrative embodiments are described with respect to specific actual or hypothetical components only as examples. Any specific manifestations of these and other similar artifacts are not intended to be limiting to the invention. Any suitable manifestation of these and other similar artifacts can be selected within the scope of the illustrative embodiments.

The examples in this disclosure are used only for the clarity of the description and are not limiting to the illustrative embodiments. Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

Furthermore, the illustrative embodiments may be implemented with respect to any type of data, data source, or access to a data source over a data network. Any type of data storage device may provide the data to an embodiment of the invention, either locally at a data processing system or over a data network, within the scope of the invention. Where an embodiment is described using a mobile device, any type of data storage device suitable for use with the mobile device may provide the data to such embodiment, either locally at the mobile device or over a data network, within the scope of the illustrative embodiments.

The illustrative embodiments are described using specific code, computer readable storage media, high-level features, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. For example, other comparable mobile devices, structures, systems, applications, or architectures therefor, may be used in conjunction with such embodiment of the invention within the scope of the invention. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

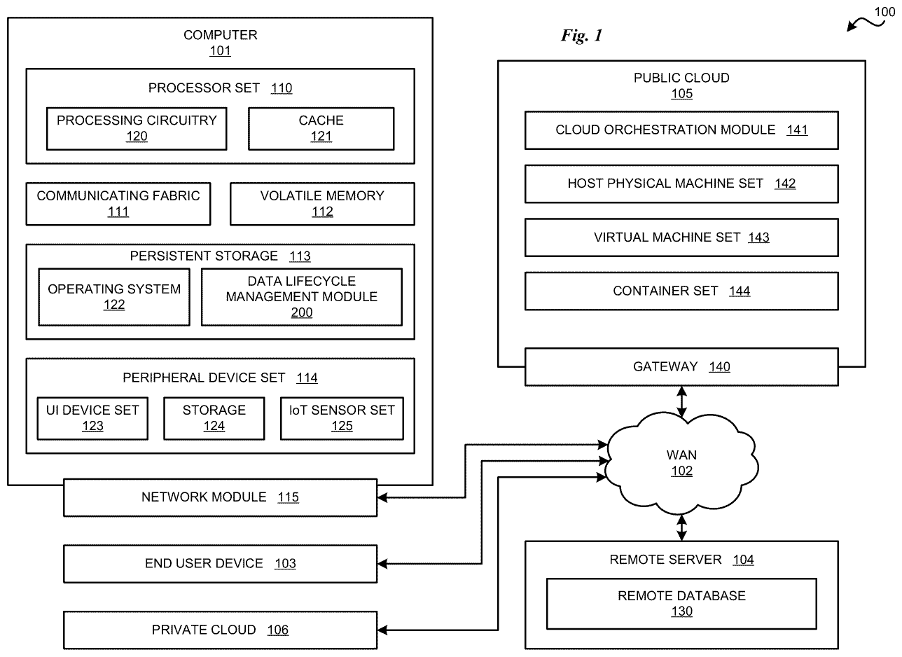

FIG. 1 depicts a block diagram of a computing environment 100. Computing environment 100 contains an example of an environment for the execution of at least some of the computer code involved in performing the inventive methods, such as data lifecycle management module 200 that provides data sparsity based index lifecycle management. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, volatile memory 112 is located in a single package and is internal to computer 101, but, alternatively or additionally, volatile memory 112 may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 012 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Measured service: cloud systems automatically control and optimize resource use by leveraging a metering capability at some level of abstraction appropriate to the type of service (e.g., storage, processing, bandwidth, and active user accounts). Resource usage can be monitored, controlled, reported, and invoiced, providing transparency for both the provider and consumer of the utilized service.

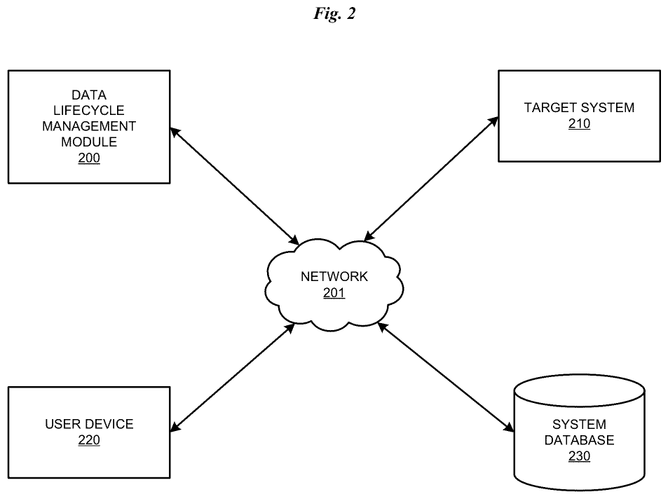

FIG. 2 depicts a block diagram of an example computing environment in accordance with an illustrative embodiment. In the illustrated embodiment, the data lifecycle management module 200 includes the data lifecycle management module 200 of FIG. 1.

In the illustrative embodiment, the data lifecycle management module 200 is configured to extract, transmit, modify, and/or delete data at different predefined stages of an index lifecycle management (ILM) policy. In an embodiment, the data lifecycle management module 200 provides a data sparsity processing method, which can dilute the data at different stages of the ILM policy with different density at different rates and/or degrees. In an embodiment, the data lifecycle management module 200 is configured to dynamically manage the data sparse in IT operational metric data lifecycle.

In an embodiment, the data lifecycle management module 200 introduces data sparsity into various phases or stages of an index lifecycle management system and deletes the related index and edge data from each stage of an ILM policy. In an embodiment, the data lifecycle management module 200 can modify, remove, and/or delete data at different rates and/or degrees at different stages besides a final delete stage, including, for example from hot and warm cold storage, in accordance with an ILM policy.

In an embodiment, the data lifecycle management module 200 includes a monitor module, a data collection module, a decision analysis module, and a data sparsity module. In an embodiment, a monitor module is configured for monitoring data changes, data insight features, objective features, and user interactions within the database. The monitor module tracks and analyzes various aspects of the data to provide real-time insights into the database activity. In an embodiment, a data collection module is configured for continuously collecting data features from the monitor module and generating feature maps for different classifications.

In an embodiment, a decision analysis module is configured for training models and generating decisions based on the relationship between data features and user query features obtained from the data collection module. The decision analysis module generates a density curve to visualize the distribution of data features. In an embodiment, a data sparsity module is configured for processing data sparsity by adjusting data density at different stages of the data lifecycle based on the density curve generated in the decision analysis module. By dynamically managing data density, the data sparsity module optimizes storage space utilization while ensuring that essential data remains accessible and usable. Embodiments of the present disclosure provide a sparse processing method to dilute data at different stages with different density.

In the illustrated embodiment, the system database 230 includes a repository for all data related to target system 210. In an embodiment, system database 230 includes a set of indices corresponding to data stored on system database 230. In an embodiment, the indices of the system database 230 are managed according to an ILM policy. In an embodiment, the data lifecycle management module 200 sets the ILM policy and defines any stages, phases, associated policies, conditions, and/or constraints associated with the ILM policy.

In the illustrated embodiment, user device 220 includes a computing device configured to facilitate user interaction with the data lifecycle management module 200 via network 201, thereby enabling a user to engage with index lifecycle management operations related to target system 210. Accordingly, user device 220 may serve as an interface through which users can communicate instructions, commands, or requests to the data lifecycle management module 200, initiating related actions and overseeing the target system's index searching performance. Through user device 220, a user can access a user interface or application that allows the user to interact with the data lifecycle management module 200. Users may input commands, configure settings, and monitor system performance through the interface provided by user device 220.

In an embodiment, user device 220 may support various communication channels, such as a graphical user interface (GUI), a command-line interface (CLI), a web-based portal, or a mobile application, depending on the system's design and user requirements. Users can communicate with the data lifecycle management module 200 in real-time to view visualization related to index lifecycle management performance metrics.

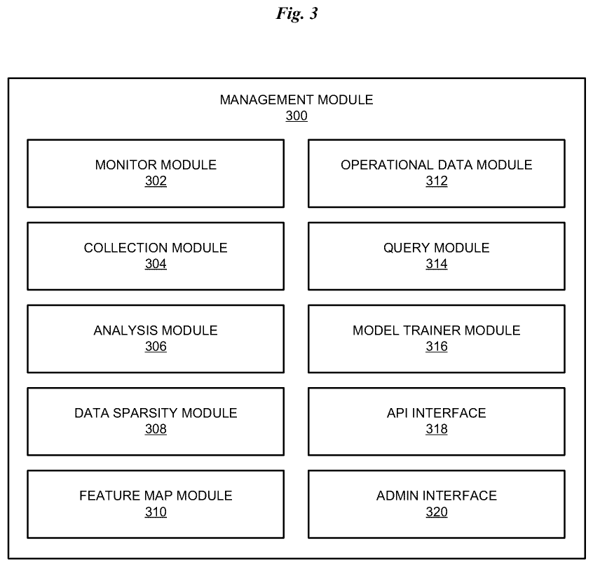

FIG. 3 depicts a block diagram of an example database management system software management module 300 in accordance with an illustrative embodiment. In the illustrated embodiment, management module 300 is an example of data lifecycle management module 200 FIG. 2. In the illustrated embodiment, the management module 300 includes a software module including a plurality of other software modules, including a monitor module 302, a collection module 304, an analysis module 306, a data sparse module 308, a feature map module 310, an operational data module 312, a query module 314, a model trainer module 316, an API module 318, and an administrator interface 320. In alternative embodiments, management module 300 can include some or all of the functionality described herein but grouped differently into one or more modules. In some embodiments, the functionality described herein is distributed among a plurality of systems, which can include combinations of software and/or hardware-based systems, for example Application-Specific Integrated Circuits (ASICs), computer programs, or smart phone applications.

In some embodiments, the management module 300 comprises a physical computing device, including but not limited to, a general-purpose computer, a mainframe computer, a supercomputer, a quantum computer, a computer server, a personal computer, a laptop, a smartphone, a tablet, a personal digital assistant (PDA), etc., and any combination thereof. In some embodiments, the management module 300 comprises specialized hardware, such as for example, a Application-Specific Integrated Circuit (ASIC) or Field-Programmable Gate Array (FPGA) for accelerated processing of specific tasks, routines, algorithms, training operations, etc. In some embodiments, the management module 300 may include a combination of physical and virtualized components, as well as may be partially or entirely virtualized on a virtual machine.

In the illustrated embodiment, the monitor module 302 includes a software module configured to monitor the data change, data insight features, objective features, user interactions, etc. In the illustrated embodiment, the monitor module 302 collects data to transmit to data collection module 304. In an embodiment, the monitor module 302 collects feature data that may include, but is not limited to, data streaming to indices, frequencies of queries, alert data sources, data change rate, baseline gap, and/or data age.

In the illustrated embodiment, the data collection module 304 includes a software module configured to continuously collect data features from data received from the monitor module 302. In an embodiment, data collection module 304 transmits feature data to feature map module 310 to generate features maps for different classifications. In the illustrated embodiment, the feature map module 310 generates one or more features maps for one or more different classifications.

In the illustrated embodiment, the analysis module 306 includes a software module configured to train and generate a graph and decision determination according to relationship of data features and user query features generated in Data Collection Module and generate a density curve. In an embodiment, the analysis module 306 provides a data density decision curve which provides a lifecycle phase evaluation result according to the feature maps generated by feature map module 310. In an embodiment, the analysis module 306 employs a hybrid polynomial regression model that represents the density which changes with time and data feature. An example hybrid polynomial regression model is shown below:

y=α0+α1 t+α2 t+ . . . +αi t+β0 +β1 tk+ . . . +βj tm+γ0 +γ1 t+ . . . +γn tp+ϵ

In the above equation, a first feature map may correspond to linear regression. A second feature map may correspond to non 0 power polynomial regression. A third feature map may correspond to 0 power included polynomial regression. Further in accordance with the above equation, each y represents the density which changes with time and the data feature, β represents the data density impact coefficient of each data feature, and t represents the time. Further, k, m, p represents the power of time for which each data feature will have different impact power, which could be linear or polynomial.

The hybrid polynomial regression model combines linear and polynomial regression methods to analyze how data density evolves during different lifecycle phases. The hybrid polynomial regression model utilizes three types of feature maps, each corresponding to a different regression technique. The first feature map employs linear regression, capturing the direct, proportional relationship between time and data density. The second feature map applies a polynomial regression model that includes only non-zero powers of time, allowing it to account for more complex, non-linear trends without including constant terms. The third feature map also uses polynomial regression but includes the zero-power term (i.e., the constant term), resulting in a more complete polynomial representation. Each feature map contributes a unique perspective on how data features influence density over time, allowing for a more flexible and robust analysis within the decision framework.

In the illustrated embodiment, the data sparse module 308 includes a software module configured to process data sparsity with different density in different lifecycle phases according to the density curve generated in decision analysis module 306. In an embodiment, the polyline data density curve can be simplified using a vertex reduction technique, which involves reducing the number of vertices or data points that define the curve while preserving its essential characteristics. By applying a vertex reduction technique to the polyline data density decision curve, the process iteratively removes less significant vertices from the curve, resulting in a simplified polyline that closely approximates the original shape of the curve. By simplifying the polyline data density decision curve through vertex reduction, organizations can enhance data visualization, optimize data processing efficiency, and improve decision-making processes based on the modified representation of data density patterns.

In the illustrated embodiment, the data sparse module 308 dilutes index data according to the modified polyline density curve by using the curve as a guide to identify data points that can be removed or reduced in granularity. The modified polyline density curve provides a simplified representation of data density patterns, highlighting areas of data sparsity or lower significance. By leveraging the information from the modified curve, the process identifies data points that contribute less to the overall data distribution and may be candidates for dilution. Data points that are deleted from the curve, based on their lower importance or density, correspond to candidate data that is eligible for dilution. These data points are considered less essential or less frequently accessed, making them suitable for reduction in granularity or removal to optimize storage space and improve data processing efficiency.

In the illustrated embodiment, the feature map module 310 includes a software module configured to generate a feature map. In the illustrated embodiment, the feature map module 310 generates one or more features maps for one or more different classifications. In an embodiment, the feature map module 310 generates three feature maps according to three categories as follows.

First Feature Map: Data features, which includes data source objective information, such as for example, data age, data rate, space left, etc.

Second Feature Map: User interactions, may include user interactions with data sources, such as for example, queries, alerts, operations, etc.

Third Feature Map: Data insights, which may include data source privacy information, such as for example, change rate, baseline gap, etc.

In the illustrated embodiment, the operational data module 312 includes a software module configured to store and transmit operational IT data. In the illustrated embodiment, the query module 314 includes a software module configured to transmit queries from users and applications.

In the illustrated embodiment, the model trainer module 316 includes a software module configured to train one or more machine learning models described herein. In an embodiment, model training module 316 includes a data preparation module, an algorithm module, a training engine, and a machine learning model. In alternative embodiments, model training module 316 can include some or all of the functionality described herein but grouped differently into one or more modules. In some embodiments, model trainer module 316 generates a machine learning model based on one or more known machine learning algorithms. In an embodiment, model trainer module 316 includes a training engine that trains machine learning model using training a dataset.

In the illustrated embodiment, the model trainer module 316 is configured to train a polynomial linear regression model, which employs a regression analysis technique that models the relationship between independent variables and the dependent variable as an nth-degree polynomial. The training process begins with data preparation, where the dataset is cleaned, missing values are handled, and the data is split into training and testing sets. Subsequently, the module selects relevant features to be used in training the polynomial linear regression model based on their predictive power. The polynomial regression model is then initialized by specifying the degree of the polynomial, such as quadratic or cubic, to best fit the data. During model training, the module adjusts the coefficients of the polynomial equation to minimize the error between predicted and actual values in the training data. Following training, the model's performance is evaluated using the testing dataset to assess its generalization and predictive accuracy. If needed, the model trainer module may fine-tune the polynomial linear regression model by adjusting hyperparameters or exploring different polynomial degrees to enhance its predictive capabilities. Through these steps, the model trainer module effectively trains a polynomial linear regression model for making predictions and analyzing data in diverse applications.

In the illustrated embodiment, the API module 318 includes one or more application programming interfaces and serves as the interface through which users and/or applications interact with the management module 300 and/or agents orchestrated by the management module 300 and facilitates the exchange of information between the users and/or applications and these modules. In an embodiment, the API module 318 is configured to interact with any or all other modules within management module 300 to relay user input and queries, receive output execution results and responses, and provide feedback on the effectiveness of the system. In some embodiments, management module 300 connects with API gateway via any suitable network or combination of networks such as the Internet, etc. and uses any suitable communication protocols such as Wi-Fi, Bluetooth, etc. to connect to external systems required to access to perform certain tasks. Further, the API gateway may transmit service requests received from a client interacting with management module 300.

In the illustrated embodiment, administrative module 320 allows users with administrative privileges to perform various administrative tasks associated with management module 300 as described herein. For example, in some embodiments, administrative module 320 allows a user with administrative privileges to initiate a data collection process or network monitoring process. As another example, in some embodiments, module 320 allows a user with administrative privileges to initiate and monitor the training process performed by model training module 316, including setting desired parameters and/or hyperparameters for the training process.

In an embodiment, administrative module 320 includes a user interface configured to allow a user having sufficient privileges to oversee the operation and management of the multi-agentic system. In an embodiment, administrative module 320 controls access permissions, monitors system performance, and handles any administrative tasks related to the platform. In an embodiment, the administrative module 320 interacts with any or all other modules to promote compliance with the administrative settings. Further, a backend administration system allows users with administrative privileges to perform various administrative tasks associated with the module as described herein, such as initiating a data collection and/or correlation process, a neural network training process, defining optimization goals, defining execution parameters/criteria, defining an ILM policy, and any other defined settings discussed herein.

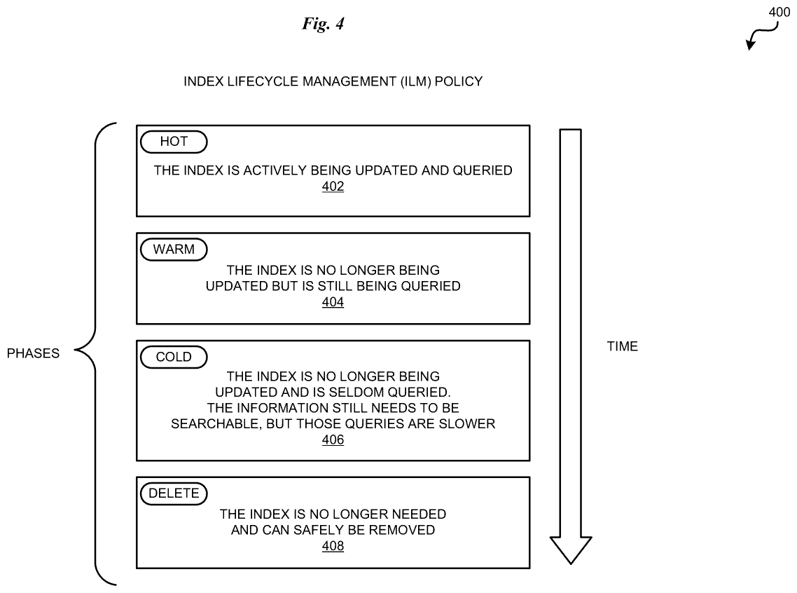

FIG. 4 depicts a block diagram of an example Index Lifecycle Management Policy in accordance with an illustrative embodiment. In the illustrated embodiment, the Index Lifecycle Management (ILM) Policy 400 defines phases in the life of an index and sets actions to be taken at each phase. In the illustrated embodiment, the IML Policy is shown including a hot phase 402, a warm phase 404, a cold phase 406, and a delete phase 408. Although the ILM Policy 400 is shown depicting four example phases, it is contemplated herein that any number of phases may be predefined.

In the illustrated embodiment, the hot phase 402 defines the index as actively being updated and queried. The hot phase 402 might include permissions for active write/read operations. In the hot phase 402, the index may be available for both read and write operations, thus enabling the index for both indexing and querying.

In the illustrated embodiment, the warm phase 404 defines the index as no longer being updated but still being queried. The warm phase 404 might include permissions for read-only operations optimized for cost and less frequent access. In the warm phase 404, the indexing may be switched off but open for querying so that the search and aggregation queries can still be served by this index.

In the illustrated embodiment, the cold phase 406 defines the index as no longer being updated and rarely (if ever) is being queried. The information still may need to be searchable, but such queries are slower. In an embodiment, the cold phase 406 might include permissions for archived data, causing the archived data to still be searchable but reducing search and data retrieval speeds for said searches. In the cold phase 406, indexing may switched off but remain open for querying, though since the queries are expected to be infrequent, index may cause queries might result in slowed response times.

In the illustrated embodiment, the delete phase 408 defines the index as no longer needed and authorized to be safely removed. In an embodiment, the cold phase 406 includes permissions for old indices that may be removed to free up resources. In the cold phase 406, an index may be deleted permanently. As such, the data is erased and resources may be freed. In an embodiment, the process takes a snapshot of the index before deleting so that the data from the snapshot can be restored at some point in the future.

Transitioning from the hot phase into every other phase may be defined according to any conditions and/or constraints. For example, once created in the hot phase 402, the index can remain in that phase or transition to any of the other four phases. Embodiments include setting an indexing life-cycle policy so that the indices can be managed automatically by the system. Defining an ILM includes defining features such as delete, rollover, or shrink indices based on certain conditions such as size of the index exceeding a certain threshold, after a certain number of days, and so forth. Embodiments define a life-cycle policy that includes predefined phases and setting the relevant action(s) on those phases. Embodiments further provide for on-demand creation or deletion of an index when needed by manual intervention.

Consider the following example scenario including setting ILM Policy 400. For logs indexed daily: Keep data hot for 7 days. Move to warm for 30 days (optimized for storage). Move to cold for another 30 days (cheaper, slower). Delete after 90 days. Accordingly, the above actions and transitions between phases can be automated using ILM Policy 400. In an embodiment, setting ILM Policy 400 includes defining a policy with phases and actions, attaching that policy to an index template, and applying the policy using an index management process as time progresses.

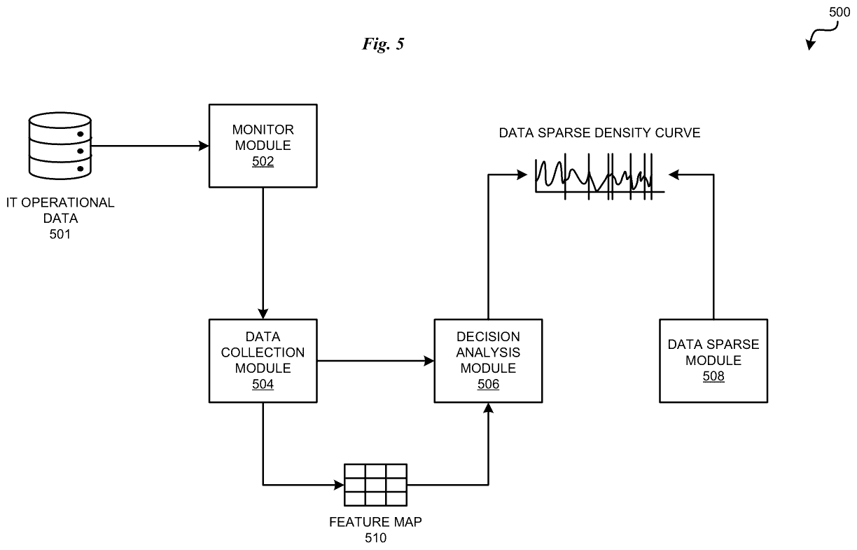

FIG. 5 depicts a block diagram of an example process for data sparsity index lifecycle management in accordance with an illustrative embodiment in accordance with an illustrative embodiment. In the illustrated embodiment, aspects of the depicted process 500 may be executed in whole or in part by data lifecycle management module 200 of FIGS. 1 and 2 and/or management module 300 of FIG. 3

In the illustrated embodiment, the monitor module 502 is configured for monitoring IT operational data 501 and collecting relevant information. In an embodiment, the monitor module 502 is configured to monitor the data change, data insight features, objective features, and user interactions. In an embodiment, the data collected by the monitor module 502 is then transmitted to the data collection module 504 that processes the collected data and generates feature maps 510 for different classifications.

In the illustrated embodiment, the decision analysis module 506 is configured to train a machine learning (ML) model and generate a decision according to relationships between data features and user query features generated in data collection module 504. By leveraging the relationships between data features and user query features identified during the data collection process, the decision analysis module 506 can generate informed decisions based on the analyzed data. In an embodiment, the decision analysis module 506 generates a density curve as an output. Accordingly, the density curve may represent the distribution of data density levels across different classifications or categories. The feature map 510 may be useful for categorizing data based on relevant features, while the density curve may provide insights into the distribution of data density within these categories.

In the illustrated embodiment, the data sparse module 508 is configured to process data sparsity with different density in different lifecycle phases according to the density curve generated by the decision analysis module 506. In an embodiment, the data sparse module 508 leverages the density curve to dynamically adjust the processing of data based on its sparsity levels at various lifecycle phases. By analyzing the density curve, the data sparse module 508 can identify areas to dilute to optimize storage space and maintain data availability.

Accordingly, analyzing the density curve allows the data sparse module 508 to identify specific areas within the dataset where data density is lower or sparser. This analysis helps the data sparse module 508 identify sections of the data that contain redundant, less critical, or less frequently accessed information that can be safely diluted or reduced without compromising the overall integrity or utility of the dataset. By identifying these sparse areas through the density curve analysis, the data sparse module 508 can strategically apply data dilution techniques to optimize storage space. Data dilution involves reducing the density or volume of data in these identified areas by removing redundant or less critical information, aggregating data points, or applying compression algorithms. This process effectively reduces the overall data volume, leading to significant storage space savings without sacrificing essential data elements.

Embodiments of the present disclosure include constructing a hybrid polynomial regression model based on the feature maps. In an embodiment, the hybrid polynomial regression model outputs a data density curve based on the input feature maps. Accordingly, the data density curve provides an evaluation of an index at a particular stage in an ILM policy based on the parameters captured by the input feature maps. In an embodiment, the data density curve includes a polyline that represents density which changes with respect to a feature data. Vertices (points) on the data density curve may be removed according to a vertex reduction algorithm, as described in greater detail herein. In an embodiment, data corresponding to points deleted from the density curve is deleted from the from the index. Accordingly, deleting index data in the manner described above according to the density curve effectively dilutes an index at a particular stage in an ILM policy. Further, the described vertex reduction algorithm only removes non-essential data points from the density curve, thereby effectively preserving the functionality of the index data structure. Accordingly, after performing the vertex reduction algorithm, the index still maintains the same or similar functionality as before, since essential data points have been preserved on the density curve. Any data point removed from the density curve according to the algorithm is hereby considered a non-essential data point, whereas any data point not removed from the density curve is considered an essential data point.

Reducing the number of vertices in a polyline includes reducing the number of vertices or points that define the shape of the line while preserving the essential characteristics. A polyline is a connected sequence of line segments that form a continuous path in two-dimensional space. Reducing the vertices in a polyline is often done to optimize the representation of the line for various purposes, such as improving rendering performance, reducing storage space, or enhancing visualization efficiency. By reducing the vertices in a polyline, the resulting simplified shape retains the essential features of the original line while requiring fewer data points to represent it.

The reduction of vertices in a polyline can be achieved through various algorithms and techniques. An embodiment employs an algorithm that simplifies a polyline by recursively dividing it into smaller segments and retaining only the vertices that contribute significantly to the overall shape of the line. Less important vertices that do not significantly affect the shape are removed, resulting in a simplified polyline. Another embodiment employs an algorithm that simplifies a polyline by iteratively removing the vertices with the least importance, based on a measure of the area of the triangle formed by three consecutive vertices. Vertices that contribute less to the overall shape are eliminated, leading to a reduced vertex count. Another employs a Another line smoothing techniques that approximate the original shape with fewer vertices while maintaining the overall curvature and smoothness of the line.

Reduction in vertices maintains overall structure and integrity of the polyline while decreasing data storage needs. As a result, the performance and efficiency of data processing and visualization are enhanced, as the computational load is reduced due to the decreased number of vertices. Additionally, the reduction of visual noise in the representation of the data leads to clearer and more concise data visualization, improving the interpretability and usability of the data for analysis and decision-making purposes. Accordingly, visual noise may include outlier data points that may distort visualization of the data otherwise.

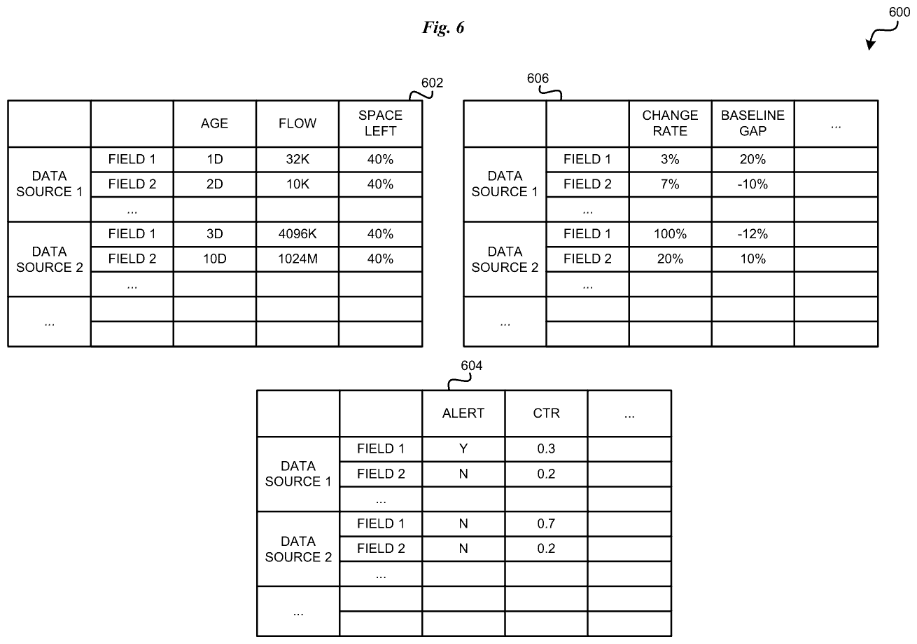

FIG. 6 depicts a block diagram of example feature mappings in accordance with an illustrative embodiment. In the illustrated embodiment, the set of feature mappings includes a first feature mapping 602, a second feature mapping 604, and a third feature mapping 606. Although three example feature mappings are shown, embodiments of the present disclosure consider generating and utilizing any number of feature mappings based on any number and combination of data features.

In the illustrated embodiment, the monitor module collects relevant data streams into the indices of the feature maps shown. These parameters are used to define the example feature map shown. Accordingly, the feature maps show some data feature organized according to different feature maps. In the illustrated embodiment, the first feature mapping 602 includes a feature map including a data feature map. In the illustrated embodiment, the second feature mapping 604 includes a includes a feature map including a user interaction feature map. In the illustrated embodiment, the third feature mapping 606 includes a includes a feature map including a data insight feature map.

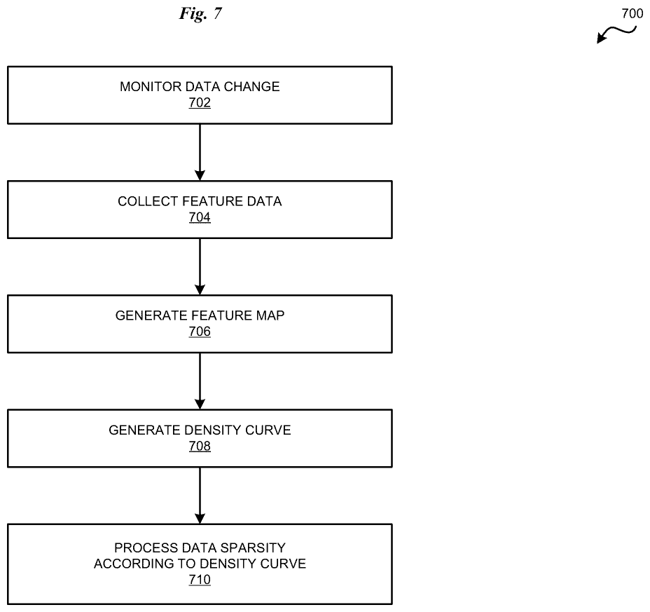

FIG. 7 depicts a flowchart of an example process for data sparsity index lifecycle management in accordance with an illustrative embodiment. In an embodiment, data lifecycle management module 200 of FIGS. 1 and 2, management module 300 of FIG. 3 carries out some or all of the steps of process 700.

In an embodiment, at step 702, the process includes monitoring changes in IT operational data. In an embodiment, a monitor module within index management application observes and tracks variations, updates, and trends in the IT operational data, including data changes, insights, objective features, and user interactions.

In an embodiment, at step 704, the process includes collecting and feature data corresponding to the IT operational data. In an embodiment, a collection module within an index management application gathers relevant information from the monitored IT operational data, including metrics, logs, events, and performance indicators. This collected feature data serves as the foundation for further analysis and processing within the data management system.

In an embodiment, at step 706, the process includes generating a feature map based on the feature data collected and extracted from the IT operational data. In an embodiment, a feature map module within an index management application structures and organizes the feature data into a coherent representation that categorizes and classifies the data based on selected attributes and characteristics.

In an embodiment, at step 708, the process includes generating a density curve based on the feature map. In an embodiment, a decision analysis module within an index management application uses the structured feature map to analyze the distribution of data density across different classifications or categories. The density curve visually represents the density levels within the dataset, offering insights into the concentration and dispersion of data points across various features and classifications.

In an embodiment, at step 710, the process includes processing data sparsity according to the density curve. In an embodiment, a data sparse module within an index management application uses the density curve to identify areas of data sparsity and applies data processing techniques such as data dilution, aggregation, or compression to optimize storage space while maintaining data availability. This step ensures that data sparsity is managed effectively throughout the data lifecycle, aligning with the density curve insights for efficient data processing and management.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “illustrative” is used herein to mean “serving as an example, instance or illustration.” Any embodiment or design described herein as “illustrative” is not necessarily to be construed as preferred or advantageous over other embodiments or designs. The terms “at least one” and “one or more” are understood to include any integer number greater than or equal to one, i.e., one, two, three, four, etc. The terms “a plurality” are understood to include any integer number greater than or equal to two, i.e., two, three, four, five, etc. The term “connection” can include an indirect “connection” and a direct “connection.”

References in the specification to “one embodiment,” “an embodiment,” “an example embodiment,” etc., indicate that the embodiment described can include a particular feature, structure, or characteristic, but every embodiment may or may not include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

Thus, a computer implemented method, system or apparatus, and computer program product are provided in the illustrative embodiments for managing participation in online communities and other related features, functions, or operations. Where an embodiment or a portion thereof is described with respect to a type of device, the computer implemented method, system or apparatus, the computer program product, or a portion thereof, are adapted or configured for use with a suitable and comparable manifestation of that type of device.

Where an embodiment is described as implemented in an application, the delivery of the application in a Software as a Service (SaaS) model is contemplated within the scope of the illustrative embodiments. In a SaaS model, the capability of the application implementing an embodiment is provided to a user by executing the application in a cloud infrastructure. The user can access the application using a variety of client devices through a thin client interface such as a web browser (e.g., web-based e-mail), or other light-weight client-applications. The user does not manage or control the underlying cloud infrastructure including the network, servers, operating systems, or the storage of the cloud infrastructure. In some cases, the user may not even manage or control the capabilities of the SaaS application. In some other cases, the SaaS implementation of the application may permit a possible exception of limited user-specific application configuration settings.

Embodiments of the present invention may also be delivered as part of a service engagement with a client corporation, nonprofit organization, government entity, internal organizational structure, or the like. Aspects of these embodiments may include configuring a computer system to perform, and deploying software, hardware, and web services that implement, some or all of the methods described herein. Aspects of these embodiments may also include analyzing the client's operations, creating recommendations responsive to the analysis, building systems that implement portions of the recommendations, integrating the systems into existing processes and infrastructure, metering use of the systems, allocating expenses to users of the systems, and billing for use of the systems. Although the above embodiments of present invention each have been described by stating their individual advantages, respectively, present invention is not limited to a particular combination thereof. To the contrary, such embodiments may also be combined in any way and number according to the intended deployment of present invention without losing their beneficial effects.

What is claimed is:

1. A computer-implemented method comprising:
configuring an indexing mechanism of a database management system application to enforce an index lifecycle management (ILM) policy, the ILM policy defining a set of stages, each stage defining respective data handling permissions for indices of a set of indices managed by the indexing mechanism;
executing using a monitor module of the database management system application a monitoring process, the monitoring process producing database operational data;
extracting using a collector module of the database management system application a set of features from the database operational data;
constructing using a feature map module of the database management system application a set of feature maps based on the set of features extracted from the database operational data;
generating using a decision analysis module of the database management system application a data density decision curve based on the set of feature maps;
identifying using the decision analysis module of the database management system application a first candidate data set belonging to a first index of the set of indices associated with a first stage of the ILM policy, the first candidate data set eligible for dilution based on the data density decision curve;
identifying using the decision analysis module of the database management system application a second candidate data set belonging to a second index of the set of indices associated with a second stage of the ILM policy, the second candidate data eligible for dilution based on the data density decision curve;
diluting using a data sparsity module of the database management system application, upon identifying the first candidate data set eligible for dilution, the first candidate data set; and
diluting using the data sparsity module of the database management system application, upon identifying the second candidate data set eligible for dilution, the second candidate data set.

2. The computer-implemented method of claim 1, further comprising:
identifying using the decision analysis module of the database management system application a third candidate data set belonging to a third index of the set of indices associated with a third stage of the ILM policy, the third candidate data eligible for dilution based on the data density decision curve; and
diluting using the data sparsity module of the database management system application, upon identifying the third candidate data set eligible for dilution, the third candidate data set.

3. The computer-implemented method of claim 1, further comprising:
identifying using the decision analysis module of the database management system application a fourth candidate data set belonging to a fourth index of the set of indices associated with a fourth stage of the ILM policy, the fourth candidate data eligible for dilution based on the data density decision curve; and
diluting using the data sparsity module of the database management system application, upon identifying the third candidate data set eligible for dilution, the fourth candidate data set.

4. The computer-implemented method of claim 1, wherein the diluting the first candidate data set is according to a first degree, wherein the diluting the second candidate data set is according to a second degree, and wherein the first degree is different from the second degree.

5. The computer-implemented method of claim 1, wherein the generating the data density decision curve based on the feature maps comprises constructing a hybrid polynomial regression model based on the feature maps, the hybrid polynomial regression model outputting the data density decision curve responsive to inputting the feature maps.

6. The computer-implemented method of claim 1, further comprising
modifying the density curve, the modifying the density curve producing a modified density curve, the modified density curve comprising fewer nodes than the density curve; and
diluting using the data sparsity module of the database management system application the first candidate data set based on the modified density curve.

7. A computer program product comprising one or more computer readable storage media, and program instructions collectively stored on the one or more computer readable storage media, the program instructions executable by a processor to cause the processor to perform operations comprising:
configuring an indexing mechanism of a database management system application to enforce an index lifecycle management (ILM) policy, the ILM policy defining a set of stages, each stage defining respective data handling permissions for indices of a set of indices managed by the indexing mechanism;
executing using a monitor module of the database management system application a monitoring process, the monitoring process producing database operational data;
extracting using a collector module of the database management system application a set of features from the database operational data;
constructing using a feature map module of the database management system application a set of feature maps based on the set of features extracted from the database operational data;
generating using a decision analysis module of the database management system application a data density decision curve based on the set of feature maps;
identifying using the decision analysis module of the database management system application a first candidate data set belonging to a first index of the set of indices associated with a first stage of the ILM policy, the first candidate data set eligible for dilution based on the data density decision curve;
identifying using the decision analysis module of the database management system application a second candidate data set belonging to a second index of the set of indices associated with a second stage of the ILM policy, the second candidate data eligible for dilution based on the data density decision curve;
diluting using a data sparsity module of the database management system application, upon identifying the first candidate data set eligible for dilution, the first candidate data set; and
diluting using the data sparsity module of the database management system application, upon identifying the second candidate data set eligible for dilution, the second candidate data set.

8. The computer program product of claim 7, wherein the stored program instructions are stored in a computer readable storage device in a data processing system, and wherein the stored program instructions are transferred over a network from a remote data processing system.

9. The computer program product of claim 7, wherein the stored program instructions are stored in a computer readable storage device in a server data processing system, and wherein the stored program instructions are downloaded in response to a request over a network to a remote data processing system for use in a computer readable storage device associated with the remote data processing system, further comprising:
program instructions to meter use of the program instructions associated with the request; and
program instructions to generate an invoice based on the metered use.

10. The computer program product of claim 7, further comprising:
identifying using the decision analysis module of the database management system application a third candidate data set belonging to a third index of the set of indices associated with a third stage of the ILM policy, the third candidate data eligible for dilution based on the data density decision curve; and
diluting using the data sparsity module of the database management system application, upon identifying the third candidate data set eligible for dilution, the third candidate data set.

11. The computer program product of claim 7, further comprising:
identifying using the decision analysis module of the database management system application a fourth candidate data set belonging to a fourth index of the set of indices associated with a fourth stage of the ILM policy, the fourth candidate data eligible for dilution based on the data density decision curve; and
diluting using the data sparsity module of the database management system application, upon identifying the third candidate data set eligible for dilution, the fourth candidate data set.

12. The computer program product of claim 7, wherein the diluting the first candidate data set is according to a first degree, wherein the diluting the second candidate data set is according to a second degree, and wherein the first degree is different from the second degree.

13. The computer program product of claim 7, wherein the generating the data density decision curve based on the feature maps comprises constructing a hybrid polynomial regression model based on the feature maps, the hybrid polynomial regression model outputting the data density decision curve responsive to inputting the feature maps.

14. The computer program product of claim 7, further comprising
modifying the density curve, the modifying the data density decision curve producing a modified density curve, the modified density curve comprising fewer nodes than the density curve; and
diluting using the data sparsity module of the database management system application the first candidate data set based on the modified data density decision curve.

15. A computer system comprising a processor and one or more computer readable storage media, and program instructions collectively stored on the one or more computer readable storage media, the program instructions executable by the processor to cause the processor to perform operations comprising:
configuring an indexing mechanism of a database management system application to enforce an index lifecycle management (ILM) policy, the ILM policy defining a set of stages, each stage defining respective data handling permissions for indices of a set of indices managed by the indexing mechanism;
executing using a monitor module of the database management system application a monitoring process, the monitoring process producing database operational data;
extracting using a collector module of the database management system application a set of features from the database operational data;
constructing using a feature map module of the database management system application a set of feature maps based on the set of features extracted from the database operational data;
generating using a decision analysis module of the database management system application a data density decision curve based on the set of feature maps;
identifying using the decision analysis module of the database management system application a first candidate data set belonging to a first index of the set of indices associated with a first stage of the ILM policy, the first candidate data set eligible for dilution based on the data density decision curve;
identifying using the decision analysis module of the database management system application a second candidate data set belonging to a second index of the set of indices associated with a second stage of the ILM policy, the second candidate data eligible for dilution based on the data density decision curve;
diluting using a data sparsity module of the database management system application, upon identifying the first candidate data set eligible for dilution, the first candidate data set; and
diluting using the data sparsity module of the database management system application, upon identifying the second candidate data set eligible for dilution, the second candidate data set.

16. The computer system of claim 15, further comprising:
identifying using the decision analysis module of the database management system application a third candidate data set belonging to a third index of the set of indices associated with a third stage of the ILM policy, the third candidate data eligible for dilution based on the data density decision curve; and
diluting using the data sparsity module of the database management system application, upon identifying the third candidate data set eligible for dilution, the third candidate data set.

17. The computer system of claim 15, further comprising:
identifying using the decision analysis module of the database management system application a fourth candidate data set belonging to a fourth index of the set of indices associated with a fourth stage of the ILM policy, the fourth candidate data eligible for dilution based on the data density decision curve; and
diluting using the data sparsity module of the database management system application, upon identifying the third candidate data set eligible for dilution, the fourth candidate data set.

18. The computer system of claim 15, wherein the diluting the first candidate data set is according to a first degree, wherein the diluting the second candidate data set is according to a second degree, and wherein the first degree is different from the second degree.

19. The computer system of claim 15, wherein the generating the data density decision curve based on the feature maps comprises constructing a hybrid polynomial regression model based on the feature maps, the hybrid polynomial regression model outputting the data density decision curve responsive to inputting the feature maps.

20. The computer system of claim 15, further comprising
modifying the density curve, the modifying the data density decision curve producing a modified density curve, the modified density curve comprising fewer nodes than the density curve; and
diluting using the data sparsity module of the database management system application the first candidate data set based on the modified data density decision curve.
